(19) United States
(12) Patent Application Publication
(10) Pub. No.: US 2019/0317125 A1
(43) Pub. Date: Oct. 17, 2019

(54) MICROSCOPY SAMPLE STAGE FOR GAS HYDRATE TESTS AND TEMPERATURE AND PRESSURE CONTROLLING SYSTEM OF THE STAGE

(71) Applicant: China University of Geosciences (Wuhan), Wuhan (CN)

(72) Inventors: Fulong Ning, Wuhan (CN); Li Peng, Wuhan (CN); Wei Li, Wuhan (CN); Dongdong Wang, Wuhan (CN); Ling Zhang, Wuhan (CN); Wenjia Ou, Wuhan (CN); Zhun Zhang, Wuhan (CN); Zhong Zou, Boulder, CO (US)

(21) Appl. No.: 16/384,988

(22) Filed: Apr. 16, 2019

(30) Foreign Application Priority Data
Apr. 17, 2018 (CN) 201810345635.3

(51) Int. Cl. G01Q 30/10; G01Q 30/16; G01Q 30/20; G02B 21/30; G02B 21/26

(52) U.S. Cl. CPC G01Q 30/10; G01Q 30/16; G02B 21/26; G02B 21/30; G01Q 30/20

(57) ABSTRACT

A microscopy sample stage includes a microscope carrier platform, a heating conductor mounting on the microscope carrier platform, and a pressure cover covering the sample groove for providing high pressure for the sample groove. The heating conductor includes a sample groove. The microscopy sample stage further includes a temperature sensor for detecting temperature of the sample groove, a heating resistance for heating the sample groove and a pipeline for transmitting refrigeration medium, the temperature sensor and the heating resistance are mounted on a bottom surface of the sample groove, and the pipeline is arranged inside the heat conductor surrounding the sample groove.

### CROSS REFERENCE TO RELATED APPLICATION

This application claims the priority of Chinese Patent Application No. 201810345635.3, filed on Apr. 17, 2018, the disclosure of which is incorporated herein by reference in its entirety.

### FIELD OF THE INVENTION

The subject matter herein generally relates to a field of testing morphology and mechanical properties of gas hydrates, especially for a microscopy sample stage and a temperature and pressure controlling system.

### BACKGROUND

Scanning probe microscopy (SPM), such as atomic force microscopy (AFM), is widely used to test the morphology, electrical, magnetic and mechanical properties of non-conductor, organic solids, polymers and biomolecules. The common atomic force microscope can't test unstable samples at room temperature and atmospheric pressure. For example, the gas hydrate sample can be synthesized and stabilized at low temperature and high pressure. It is very difficult to transfer gas hydrate samples. In addition the gas hydrate samples can be also kept stable at very low temperature under atmospheric pressure. So a sample stage for in-situ gas hydrates formation is necessary.

At present, semiconductor refrigeration is often used in low-temperature atomic force microscope sample stages. This method adjusts the lower temperature limit by about minus 30 degrees Centigrade, the temperature does not meet the temperature requirements of gas hydrate samples under normal pressure. Moreover, it is even rare for the sample stages with controllable pressure.

Therefore, there is room for improvement within the art.

### BRIEF DESCRIPTION OF THE DRAWINGS

Implementations of the present technology will now be described, by way of embodiments only, with reference to the attached figures.

FIG. 1 is a cross-section view of a microscopy sample stage in accordance with one embodiment.

FIG. 2 is a top view of the microscopy sample stage.

FIG. 3 is an isometric view of the microscopy sample stage.

FIG. 4 is an exploded view of the microscopy sample stage of FIG. 3.

FIG. 5 is a top view of the microscopy sample stage but removing the pressure cover and a covering plate in FIG. 1.

FIG. 6 is a cross-section view of a heating conductor comprising in the microscopy sample stage of FIG. 1.

FIG. 7 is a cross-section view of a pressure cover comprising in the microscopy sample stage of FIG. 1.

FIG. 8 is a cross-section view of a temperature and pressure controlling system in accordance with one embodiment.

### DETAILED DESCRIPTION

It will be appreciated that for simplicity and clarity of illustration, where appropriate, reference numerals have been repeated among the different FIGures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

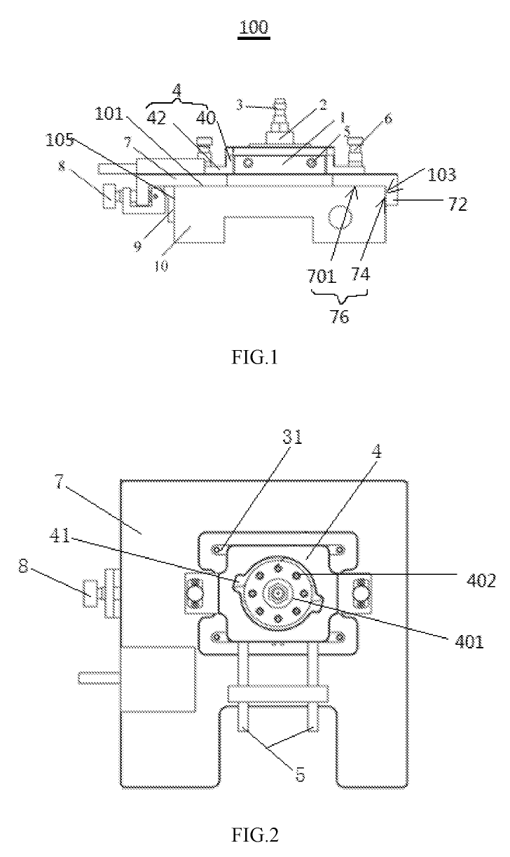

FIG. 1 illustrates a microscopy sample stage 100 according to one embodiment. The microscopy sample stage 100 is used for testing morphology, and mechanical properties of gas hydrate. The microscopy sample stage 100 includes a heating conductor 1, a pressure cover 2, a connection head 3, a covering plate 4, a base 7, a temperature sensor 13, a heating resistance 14 and a microscope carrier platform 10.

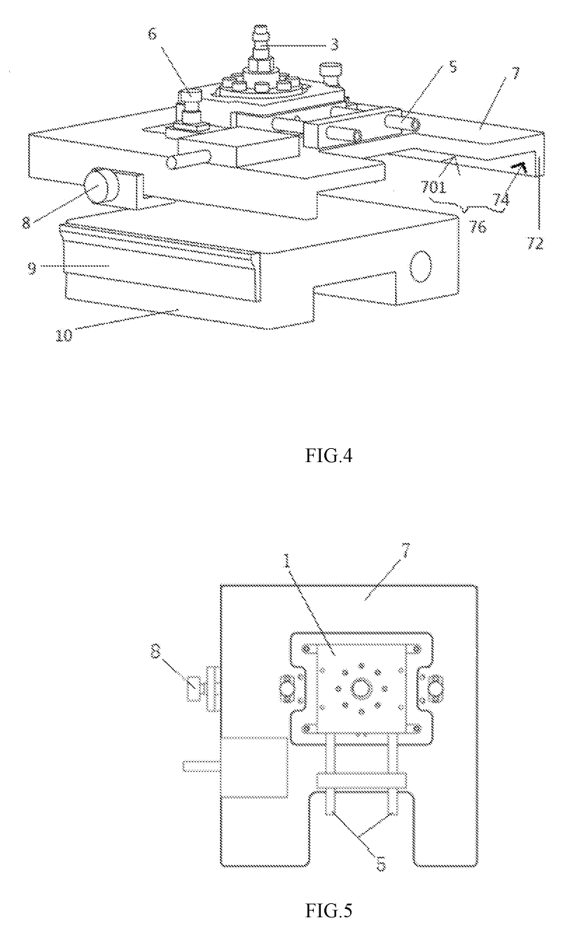

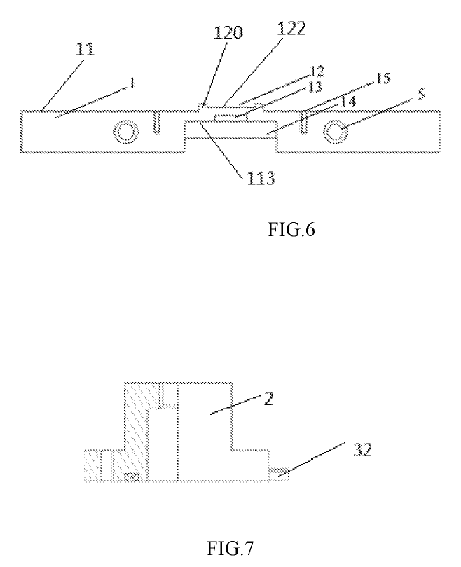

Referring now to FIG. 1 and FIG. 4, the base 7 is mounted on the microscope carrier platform 10, and the heating conductor 1 is mounted on the base 7. The heating conductor 1 is square or circular. In this embodiment, the heating conductor 1 is square, as shown in FIG. 5. Central of the heating conductor 1 is disposed a sample groove 12 for holding sample. The sample groove 12 includes a groove wall 120 protruding an upper surface of the heating conductor 1, and a thickness of the groove wall 120 is twice a depth of the sample groove 12. A bottom surface 122 of the sample groove 12 is slightly higher than an upper surface 11 of the heating conductor 1, as shown in FIG. 6. In this embodiment, an outer diameter of the groove wall 120 is about 14 mm, an inner diameter of the groove wall 120 is about 12 mm, and a depth of the sample groove 12 is 1 mm.

The temperature sensor 13 and the heating resistance 14 are distributed from top to bottom below a bottom surface of the sample groove 12, and the temperature sensor 13 is arranged on an upper surface of the heating resistance 14. In the embodiment, the bottom center of the heating conductor 1 includes an upward concave receiving space 113, a location of the concave receiving space 113 corresponds to a location of the sample groove 12. The temperature sensor 13 and the heating resistance 14 are mounted in the receiving space 113, and the lower surface of the heating resistance 14 does not extend the concave receiving space 113. The temperature sensor 13 has a certain distance from the bottom surface of the sample groove 12. The temperature sensor 13 is configured for detecting temperature of the sample groove 12, and the heating resistance 14 is configured for heating the sample groove 12. The heating conductor 1 has a good thermal conductivity. When the heating resistance 14 is electrically heated, the heat is transferred to the sample groove 12 through the heating conductor 1 to heat the sample received in the sample groove 12. Since the heating resistance 14 does not have direct contact with the sample groove 12. Instead, the heat is indirectly transferred to the sample groove 12 through the heating conductor 1, so the sample groove 12 can be evenly heated. In order to simplify the fabrication process, the heating conductor 1 and the sample groove 12 are integrated molded.

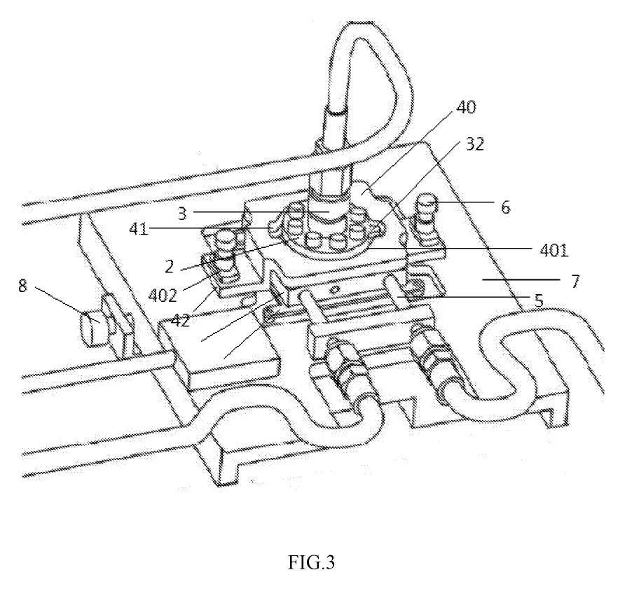

Referring now to FIGS. 2 and 3, the heating conductor 1 is provided with a pipeline 5. The pipeline 5 is configured for transmitting refrigeration medium, and the pipeline 5 is arranged surrounding the sample groove 12 to cool the sample groove 12. The refrigeration medium is preferably liquid nitrogen or nitrogen which is in low temperature after vaporization. Top surface of the base 7 is provided with two metal strips 31, the two metal strips 31 are parallel to each other. The two metal strips 31 are fixed to the base 7 through a column and a screw. The heating conductor 1 is fixed on the base 7 via the two metal strips 31. In order to ensure the stability of the heating conductor 1, the two metal strips 31 extend to opposite sides of the heating conductor 1. In order to prevent the heating conductor 1 from transmitting heat or low temperature to the base 7 resulting in energy waste, an insulation material is arranged between the metal strip 31 and the base 7. Adopting two metal strips 31 instead of adopting more metal strip 31 or adopting a large piece of metal block, on the one hand, saving the material and reducing the production cost; on the other hand, since more metal strips 31 or larger pieces of metal require more stub columns and screws, this will undoubtedly increase the heat transfer between the heating conductor 1 and the base 7, thereby wasting energy. The base 7 is also required to be a cold-resistant material.

Referring again to FIG. 1, the heating conductor 1 is fixed on the microscope carrier platform 10 by the base 7. The base 7 includes lateral ribs 72 extending vertically from an edge of its upper surface, the lateral ribs 72 form a rectangular frame 74. The rectangular frame 74 and the lower surface 701 of the base 7 together form a mounting space 76. The mounting space 76 covers a top surface 101 of the microscope carrier platform 10, the microscope carrier platform 10 comprises a first side wall 103 and a second side wall 105 opposite to the first wall 101, and the first side wall 103 contacts with an inside of the mounting space 76, and the second side wall 105 spaces apart with inside of the mounting space 76.

In the embodiment, the right side of the microscope carrier platform 10 touches an inside of the right side of the mounting space 76. A fastening bolt 8 transversely passes through the left side of the rectangular frame 74 is fits with the left side of the rectangular frame 74 through threads. When the fastening bolt 8 is rotated in a forward direction, it can be rotated into the mounting space 76 and the base 7 is fixed to the microscope carrier platform 10, and when the fastening bolt 8 is rotated in reverse, the fastening bolt 8 can be spun out of the mounting space 76 to remove the base 7 from the microscope carrier platform 10. The second side wall 105 of the microscope carrier platform 10 is disposed with a clamping plate 9 facing the fastening bolt 8, the fastening bolt 8 supports against the clamping plate 9. The clamping plate 9 is used to protect the microscope carrier platform 10 from being broken by the fastening bolt 8 which is rotating into the mounting space 76.

Referring to FIGS. 1 to 3, The covering plate 4 is fastened to the heating conductor 1 to buckle the heating conductor 1 downward on the upper surface of the base 7. The covering plate 4 is made from insulation material or an insulation material is provided between the covering plate 4 and the heating conductor 1. The covering plate 4 is in an arched shape and includes an n-shaped arch 40 and two wing plates 42 extending vertically from opposite edges of the arch portion. The wing plate 42 is attached to the upper surface of the base 7 and fastened to the base 7 by bolts 6.

Referring to FIGS. 1, 3, 4 and 7, in the embodiment, the covering plate 4 includes a central through hole 401 defines at central of the arch 40 and two peripheral through holes 402 defines at each wing plate 42. The wing plate 42 is fastened to the base 7 by the bolts 6 passing through the peripheral through holes 402. The central through hole 401 is use to install the pressure cover 2 to the heating conductor 1. Center of the central through hole 401 are in the same vertical line as the center of the sample groove 12 and the center of the heating resistance 14. An edge of the arch 40 is provided with notches 41, the pressure cover 2 is a tower shape, edge of a lower end of the pressure cover 2 includes a bulge 32. When the pressure cover 2 is rotated to let the bulge 32 enter in the notch 41, the pressure cover 2 is stuck in the covering plate 4 and cannot be withdrawn from the covering plate 4.

Preferably, the covering plate 4 includes two notches 41 and the two notches 41 are symmetrically arranged, the pressure cover 2 includes two bulges 32 and symmetrical arranged, and a width of the bulge 32 is less than a width of the notch 41. Thus, the bulge 32 can enter the inside of the arch 40 through the corresponding notch 41.

Lower end of the pressure cover 2 locates the central through hole 401 of the arch 40 and is fixedly connected to the heating conductor 1 through a flange. The pressure cover 2 is able to provide high pressure for the sample groove 12. The pressure cover 2 directly covers above the sample groove 12, and top of the pressure cover 2 is provided with a connection head 3. The connection head 3 is a male. The connection head 3 is connected with a high pressure spring hose 19 for conveying high pressure gas.

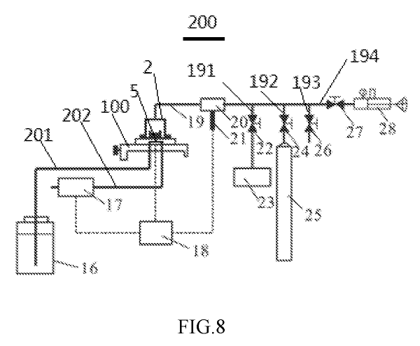

FIG. 8 illustrates a temperature and pressure controlling system 200 according to one embodiment. The temperature and pressure controlling system 200 includes the microscopy sample table 100, a cold source 16 configuring for storing a refrigeration medium, a vacuum pump 17, a high-pressure spring hose 19 connected to the pressure cover 2, a high pressure gas source 23, a high pressure gas source 25 and a controller 18.

The cold source 16 is connected to the microscopy sample table 100 through a pipe 201, the microscopy sample table 100 is connected to the cold pump 17 through a pipe 202. The pipe 201 and the pipe 202 are spring hose. These spring hoses can ensure the microscopy sample stage 100 can still be moved normally when deliver low temperature nitrogen gas.

In the embodiment, the cold source 16 is a liquid nitrogen tank. The refrigeration medium received in the cold source 16 is liquid nitrogen. One end of the pipeline 5 is connected to the cold source 16 for transmission of cold substance to the sample groove 12 and the other end of the pipeline 5 is connected to the cold pump 17.

The cold pump 17 is configure to suck a low temperature liquid nitrogen in the cold source 16. A low temperature nitrogen is formed when vaporizes the liquid nitrogen under a negative pressure, and the low temperature nitrogen flows through the pipeline 5 to realize refrigeration of the sample groove 12. When temperature of the sample groove 12 is lower than a preset temperature determined by the controller 18, the controller 18 control the temperature of the sample groove 12 to increase by adjusting the cold pump 17 to reduce the pump amount and controlling the heating resistance 14 to increase its heating power so as to. When temperature of the sample groove 12 is higher than a temperature preset by the controller 18, the controller 18 controls the cold pump 17 to increase the pump volume, and controls the heating resistance 14 to reduce its power, so as to decrease the temperature of the sample groove 12. The temperature control system with feedback communication loop is able to control the temperature of the sample groove 12 quickly and accurately.

One end of the high-pressure spring hose 19 far away the microscopy sample table 100 is divided into four branches. A first branch 191 is connected to the vacuum pump 23 through a first cut-off valve 22. The first branch 191 is used to siphon off gas in a sealing space formed by the sample groove 12 and the pressure cover 2. A second branch 192 is connected to the high pressure gas source 25 through a pressure relief valve 24. The second branch 192 is configured for injecting high pressure gas into the sealing space formed by the sample groove 12 and the pressure cover 2. A third branch 193 is connected to a cut-off valve 26, the cut-off valve 26 is a reserved valve. A fourth branch 194 is connected to a back pressure valve 28 through a second cut-off valve 27. The fourth branch 194 is used to reduce pressure of the sealing space to ensure the pressure value of the sealing space less than a preset value determined by the back pressure valve 28. Since the liquid nitrogen temperature is about minus 196 degrees Centigrade, a temperature of the heating conductor 1 can be as low as minus 196 degrees Centigrade.

The controller 18 is electrically connected to the temperature sensor 13, the cold pump 17 and the heating resistance 14. The controller 18 is configured to detect temperature of the sample groove 12, control a flow rate of the refrigeration medium in the pipeline 5 and adjust a heating power of the heating resistance 14.

A three-way pipe 20 has three ports, a first port is connected to the high-pressure spring hose 19, a second port is connected to the four branches, and a third port is provided a pressure sensor 21. The controller 18 is electrically connected to the pressure sensor 21 to detect pressure of the sealing space formed by the sample groove 12 and the pressure cover 2.

In this disclosure, a test of methane gas hydrate is taken as an example to explain how to use the temperature and pressure control system 200. The method is specified as follows:

Step 101, a deionized water is packed in the sample groove 12; the pressure cover 2 is covered on the sample groove 12, and the high pressure spring hose 19 is connected to the pressure cover 12. In the embodiment, a volume of the deionized water is about 30 microliters.

Step 102, a temperature value of the sample groove 12 is preset about minus 5 degrees Celsius through the controller 18. In the embodiment, temperature of the sample groove 12 is realized by the cold pump 17. That is, the cold pump 17 is turned on, and the temperature of the sample groove 12 is lowered by using the low temperature of nitrogen gas. Until the temperature of the sample groove 12 is minus 5 degrees Celsius, the deionized water freezes after a few seconds.

Step 103, the pressure relief valve 24 is adjusted. In the embodiment, the high pressure gas source 25 is configured to provide methane gas. When the methane gas in the high pressure gas source 25 fills the sealing space formed by the sample groove 12 and the pressure cover 2 the pressure relief valve 24 is closed.

Step 104, the first cut-off valve 22 and the vacuum pump 23 are opened to remove the impure methane gas in the sealing space and the pipeline 19.

Step 105, Step 103 and Step 104 are repeated two to three times in turn, then the first stop valve 22 and the vacuum pump 23 are closed.

Step 106, the back pressure valve 28 is adjusted to set a pressure value, and the pressure value is usually several MPa, for example 8MPa, and then the second cut-off valve 27 is opened.

Step 107, the pressure relief valve 24 is opened so that the high pressure methane gas is channeled into the pressure cover 2, the controller 18 is preset to let the temperature of the sample groove 12 is about several degrees Celsius, for example 2 degrees Celsius, and the ice in the sample groove 12 is melted, and the high pressure methane gas is gradually dissolved in the water.

Step 108, after waiting for half an hour, the controller 18 is set so that the temperature of the sample groove 12 is about minus 30 degrees Celsius, then, temperature of the sample groove 12 is increased about 2 degrees Celsius. After repeat two or three times of temperature rise and fall, the temperature is reduced to minus 80 degrees Celsius. Testing can be carried out after opening the cut-off valve 24 to release the pipeline gas pressure, remove the high-pressure spring hose 19 and flanges.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A microscopy sample stage comprising:
a microscope carrier platform;
a heating conductor mounting on the microscope carrier platform, the heating conductor comprising a sample groove; and
a pressure cover covering the sample groove for providing high pressure for the sample groove; wherein the microscopy sample stage further comprises a temperature sensor for detecting temperature of the sample groove, a heating resistance for heating the sample groove and a pipeline for transmitting refrigeration medium, the temperature sensor and the heating resistance are mounted on below the sample groove, and the pipeline is disposed inside the heat conductor and surrounds the sample groove.

2. The microscopy sample stage of claim 1, wherein:
the heating conductor is square or circular.

3. The microscopy sample stage of claim 2, wherein:
the microscopy sample stage further comprises a base, the base is mounted on the microscope carrier platform, the heating conductor is mounted on the base, and an insulation material is sandwiched between the heating conductor and the base.

4. The microscopy sample table of claim 3, wherein:
a top surface of the base is provided with two metal strips, the two metal strips are parallel to each other, and the heating conductor is fixed on the base through the two metal strips.

5. The microscopy sample table of claim 4, wherein:
the base comprises lateral ribs extending vertically from an edge of its upper surface, the lateral ribs form a frame, the frame and the lower surface of the base together form a mounting space, and the mounting space covers an upper end of the microscope carrier platform.

6. The microscopy sample stage of claim 5, wherein:
the microscope carrier platform comprises a first side wall and a second side wall opposite to the first wall, the base is fixed on the microscope carrier platform through a fastening bolt passing the lateral rib and facing the second side wall.

7. The microscopy sample table of claim 6, wherein:
the first side wall touches an inside of the mounting space, and the second side wall spaces apart with inside of the mounting space.

8. The microscopy sample stage of claim 7, wherein:
the second side wall of the microscope carrier platform is disposed with a clamping plate, the fastening bolt relies on the clamping plate.

9. The microscopy sample stage of claim 8, wherein:
top of the pressure cover is provided with a connection head, the connection head is configured for connecting with a high pressure spring hose for conveying high pressure gas to the sample groove.

10. The microscopy sample stage of claim 9, wherein:
the microscopy sample stage further comprises a covering plate, the covering plate is in an arched shape and comprises an n-shaped arch and two wing plates extending vertically from opposite edge of the arch portion, the arch covers the heating conductor and the wing plates are fastened to the base.

11. The microscopy sample stage of claim 10, wherein:
the covering plate comprises a central through hole defining at central of the arch and two peripheral through holes defining at each wing plate, the wing plate is fastened to the base by the bolts passing through the peripheral through holes, the central through hole is use to install the pressure cover to the heating conductor.

12. The microscopy sample stage of claim 11, wherein:
an edge of the arch is provided with notches, the pressure cover is a tower shape, a lower end of the pressure cover comprises bulges, and a location of the bulge is corresponded to a location of the notch.

13. The microscopy sample stage of claim 1, wherein:
the sample groove comprises a groove wall protruding an upper surface of the heating conductor, and a thickness of the groove wall is twice a depth of the sample groove

14. The microscopy sample stage of claim 13, wherein:
an outer diameter of the groove wall is about 14 mm, an inner diameter of the groove wall is about 12 mm, and a depth of the sample groove is 1 mm.

15. The microscopy sample table of claim 1, wherein:
the refrigeration medium is liquid nitrogen or vaporized liquid nitrogen.

16. A temperature and pressure controlling system comprising:
a microscopy sample stage;
a cold source for storing a refrigeration medium;
a cold pump;
a high-pressure spring hose; and
a controller; wherein the sample stage comprises:
a microscope carrier platform;
a heating conductor mounting on the microscope carrier platform, the heating conductor comprising a sample groove; and
a pressure cover covering the sample groove for providing high pressure for the sample groove; wherein the microscopy sample stage further comprises a temperature sensor for detecting temperature of the sample groove, a heating resistance for heating the sample groove and a pipeline for transmitting refrigeration medium, the temperature sensor and the heating resistance are mounted on a bottom surface of the sample groove, and the pipeline is disposed inside the heat conductor and surrounds the sample groove;
and wherein one end of the pipeline is connected to the cold source, the other end of the pipeline is connected to the cold pump, the high-pressure spring hose connected to the pressure cover for conveying high pressure gas to the sample groove, the controller is electrically connected to the temperature sensor, the cold pump and the heating resistance, the controller is configured to adjust temperature of the sample groove, the controller is also configured to control the flow rate of the cold substance in the pipeline and control the heating power of the heating resistance.

17. The temperature and pressure controlling system of claim 16, wherein:
the temperature and pressure controlling system further comprises a vacuum pump and a high pressure gas source, one end of the high-pressure spring hose far away the microscopy sample stage is divided into four branches, a first branch is connected to the vacuum pump through a first cut-off valve, the first branch is used to siphon off gas in the sample groove, a second branch is connected to the high pressure gas source through a pressure relief valve, the second branch is configured for injecting high pressure gas into the sealing space formed by the sample groove and the pressure cover, a third branch is connected to a cut-off valve and a fourth branch is connected to a back pressure valve through a second cut-off valve.
